(19) United States
(12) Patent Application Publication
(10) Pub. No.: US 2024/0049618 A1
(43) Pub. Date: Feb. 15, 2024

(54) CROP YIELD PREDICTION SYSTEM

(71) Applicant: Intelinair, Inc., Indianapolis, IN (US)

(72) Inventors: Liana Baghdasaryan, Yerevan (AM); Razmik Melikbekyan, Yerevan (AM); Arthur Dolmajian, Yerevan (AM); Jennifer Hobbs, Indianapolis, IN (US)

(73) Assignee: Intelinair, Inc., Indianapolis, IN (US)

(21) Appl. No.: 18/210,703

(22) Filed: Jun. 16, 2023

Related U.S. Application Data
(60) Provisional application No. 63/352,688, filed on Jun. 16, 2022.

(51) Int. Cl. A01B 79/00; G06V 20/10; G06V 10/75; G06V 10/30

(52) U.S. Cl. CPC A01B 79/005; G06V 20/188; G06V 10/758; G06V 10/30

(57) ABSTRACT

A yield prediction system including an information gathering unit that retrieves a plurality of images of a field over a time period, an information analysis unit that divides each image into a plurality of tiles. a pixel analysis unit that gathers at least one agronomic rule to each tile and a simulation unit that determines the yield represented by each pixel in each image based on the agronomic rules and the analysis of each tile.

### CROSS REFERENCE TO RELATED APPLICATIONS

This application claims the benefit of U.S. patent application Ser. No. 63/352,688 filed Jun. 16, 2023, titled CROP YIELD SYSTEM.

### BACKGROUND OF THE INVENTION

Crop yield forecasting is a central task in precision agriculture because of its impact on food security, economics, and scientific development. Numerous stakeholders are impacted: farmers rely on accurate predictions to make informed management decisions and take appropriate actions; commercial suppliers seek to understand how new seed varieties will perform in different areas; governments and international organizations depend on early and accurate forecasts to anticipate disruptions in food security or import/exports.

Current methods of crop yield forecasting involve reliance on manual methods and prior yields which are not accurate. Computer based yield predictions have been attempted with very little success. Therefore, a need exists for system that will accurately predict the crop yield of a particular field.

### SUMMARY OF THE INVENTION

Systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

One embodiment of the present disclosure includes a yield prediction system including an information gathering unit that retrieves a plurality of images of a field over a time period, an information analysis unit that divides each image into a plurality of tiles. a pixel analysis unit that gathers at least one agronomic rule to each tile and a simulation unit that determines the yield represented by each pixel in each image based on the agronomic rules and the analysis of each tile.

In another embodiment, each tile is a four channel image having red, blue, green and NIR reflectance.

In another embodiment, a mean square error, mean absolute error and mean absolute precent error are calculated for each tile.

In another embodiment, only the areas of each tile that are managed are used in the analysis.

In another embodiment, each tile is scaled to bring a value of a pixel in the tile to between 0-2.

In another embodiment, an encoder/decoder analyzes the pixel density for each image.

In another embodiment, the encoder/decoder analyzes shades of each pixel to determine a stress level of all areas of the field ranging from no stress to high stress.

In another embodiment, erosion and blurring are applied to each tile to remove noise from the image by the pixel analysis unit.

In another embodiment, using the stress levels of each area and the pixel and the yield density of each pixel, the encoder/decoder calculates the predicted yield of each area of the field based on the image data only.

In another embodiment, wherein each area in the image is classified based on the severity levels.

Another embodiment of the present disclosure includes a method of predicting a yield of a field including the steps of retrieving a plurality of images of a field over a time period via an information gathering unit, dividing each image into a plurality of tiles via an information analysis unit;
gathering at least one agronomic rule to each tile via a pixel analysis unit and determining the yield represented by each pixel in each image based on the at least one agronomic rules and the analysis of each tile via a simulation unit.

In another embodiment, each tile is a four channel image having red, blue, green and NIR reflectance.

In another embodiment, a mean square error, mean absolute error and mean absolute precent error are calculated for each tile.

In another embodiment, only the areas of each tile that are managed are used in the analysis.

In another embodiment, each tile is scaled to bring a value of a pixel in the tile to between 0-2.

In another embodiment, an encoder/decoder analyzes the pixel density for each image.

In another embodiment, the encoder/decoder analyzes shades of each pixel to determine a stress level of all areas of the field ranging from no stress to high stress.

In another embodiment, erosion and blurring are applied to each tile to remove noise from the image by the pixel analysis unit.

In another embodiment, using the stress levels of each area and the pixel and the yield density of each pixel, the encoder/decoder calculates the predicted yield of each area of the field based on the image data only.

In another embodiment, each area in the image is classified based on the severity levels.

### BRIEF DESCRIPTION OF THE DRAWINGS

The accompanying drawings, which are incorporated in and constitute a part of this specification, illustrate an implementation of the present invention and, together with the description, serve to explain the advantages and principles of the invention. In the drawings:

FIG. 1 depicts one embodiment of a yield predication system consistent with the present invention;

FIG. 2 depicts one embodiment of a yield analysis unit;

FIG. 3 depicts one embodiment of a communication device consistent with the present invention;

FIG. 4A depicts a schematic representation of a process to predict the crop yield of a field;

FIG. 4B depicts a schematic representation of a process to estimate crop yield of a field;

FIG. 4C depicts a schematic representation of a process of determining crop yield using an encoder/decoder to determine filed crop yield with image data only; and

FIG. 5 depicts a schematic representation of a process of generating validation data for an image.

### DETAILED DESCRIPTION OF THE INVENTION

Referring now to the drawings which depict different embodiments consistent with the present invention, wherever possible, the same reference numbers will be used throughout the drawings and the following description to refer to the same or like parts.

Yield forecasting has been a central task in computational agriculture because of its impact on agricultural management from the individual farmer to the government level. The yield predication system 100 of the present disclosure utilizes high-resolution aerial imagery and output from high-precision harvesters to predict in-field harvest values for farms in the US. By analyzing yield on a pixel level in an image of a field, farmers are provided a detailed analysis of which areas of the farm may be performing poorly so the appropriate management decisions can be made in addition to providing an improved prediction of total yield.

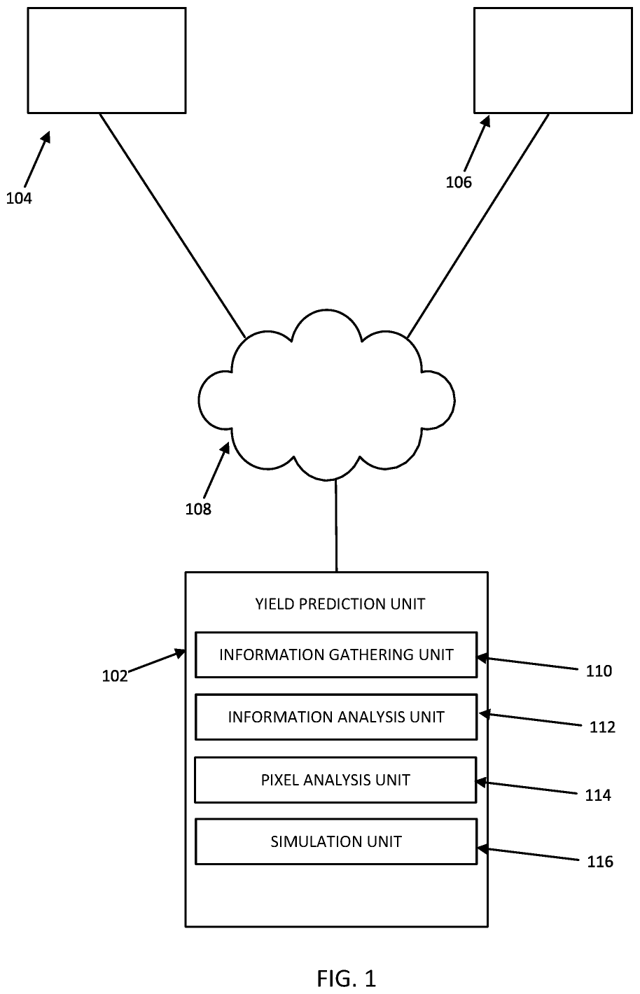

FIG. 1 depicts one embodiment of a yield prediction system 100 consistent with the present invention. The yield prediction system 100 includes a yield prediction unit 102, a communication device 1 104, a communication device 2 106 each communicatively connected via a network 108. The yield prediction unit 102 further includes an information gathering unit 110, an information analysis unit 112, a pixel analysis unit 114 and a simulation unit 116.

The information gathering unit 110 and information analysis unit 112 may be embodied by one or more servers. Alternatively, each of the pixel analysis unit 114 and simulation unit 116 may be implemented using any combination of hardware and software, whether as incorporated in a single device or as a functionally distributed across multiple platforms and devices.

In one embodiment, the network 108 is a cellular network, a TCP/IP network, or any other suitable network topology. In another embodiment, the yield prediction unit 100 may be servers, workstations, network appliances or any other suitable data storage devices. In another embodiment, the communication devices 104 and 106 may be any combination of cellular phones, telephones, personal data assistants, or any other suitable communication devices. In one embodiment, the network 102 may be any private or public communication network known to one skilled in the art such as a local area network (“LAN”), wide area network (“WAN”), peer-to-peer network, cellular network or any suitable network, using standard communication protocols. The network 108 may include hardwired as well as wireless branches.

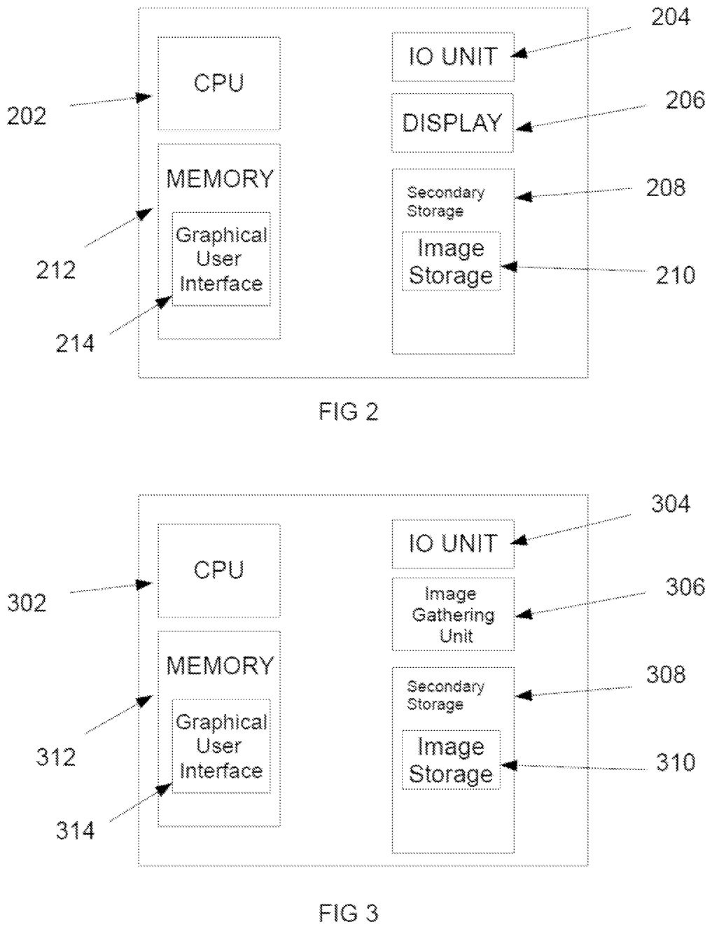

FIG. 2 depicts one embodiment of a yield prediction unit 102. The yield prediction unit 102 includes a network I/O device 204, a processor 202, a display 206 and a secondary storage 208 running image storage unit 210 and a memory 212 running a graphical user interface 214. In one embodiment, the processor 202 may be a central processing unit (“CPU”), an application specific integrated circuit (“ASIC”), a microprocessor or any other suitable processing device. The memory 212 may include a hard disk, random access memory, cache, removable media drive, mass storage or configuration suitable as storage for data, instructions, and information. In one embodiment, the memory 208 and processor 202 may be integrated. The memory may use any type of volatile or non-volatile storage techniques and mediums. The network I/O line 204 device may be a network interface card, a cellular interface card, a plain old telephone service (“POTS”) interface card, an ASCII interface card, or any other suitable network interface device.

FIG. 3 depicts one embodiment of a communication device 104/106 consistent with the present invention. The communication device 104/1106 includes a processor 302, a network I/O Unit 304, an image capture unit 306, a secondary storage unit 308 including an image storage device 310, and memory 312 running a graphical user interface 314. In one embodiment, the processor 302 may be a central processing unit (“CPU”), a application specific integrated circuit (“ASIC”), a microprocessor or any other suitable processing device. The memory 312 may include a hard disk, random access memory, cache, removable media drive, mass storage or configuration suitable as storage for data, instructions, and information. In one embodiment, the memory 312 and processor 302 may be integrated. The memory may use any type of volatile or non-volatile storage techniques and mediums. The network I/O device 304 may be a network interface card, a plain old telephone service (“POTS”) interface card, an ASCII interface card, or any other suitable network interface device.

In one embodiment, the network 108 may be any private or public communication network known to one skilled in the art such as a Local Area Network (“LAN”), Wide Area Network (“WAN”), Peer-to-Peer Network, Cellular network or any suitable network, using standard communication protocols. The network 108 may include hardwired as well as wireless branches.

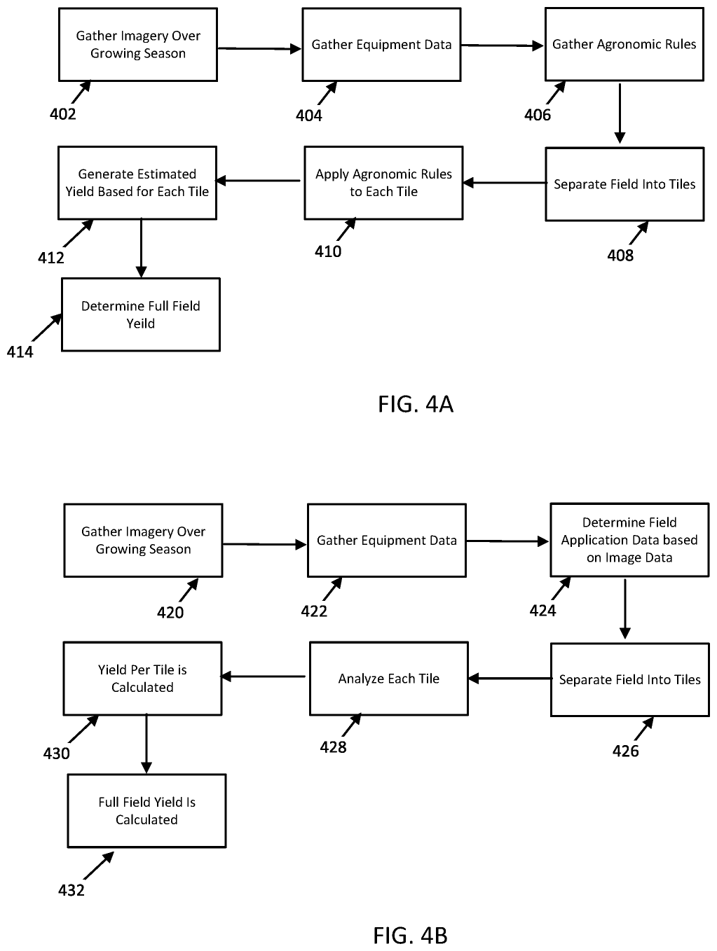

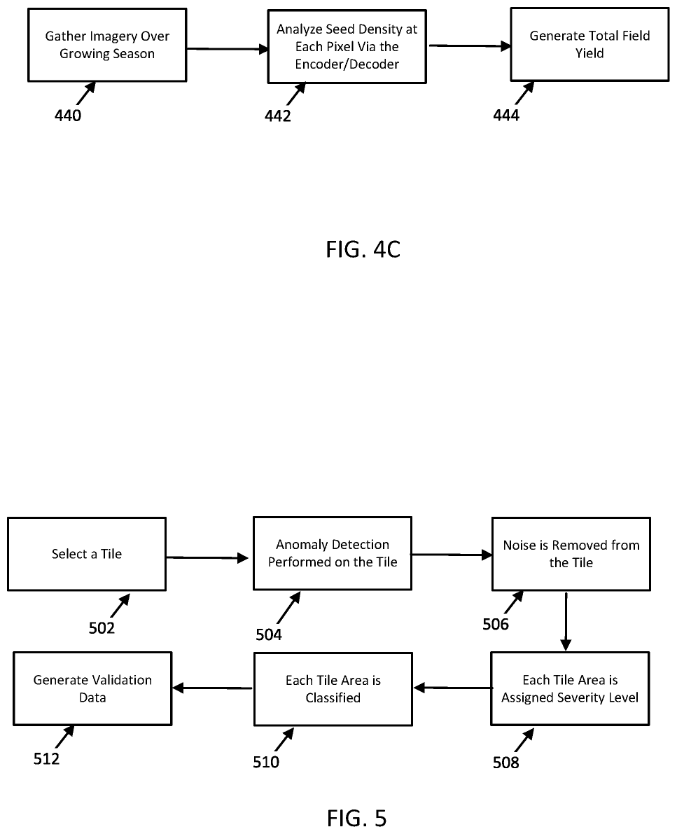

FIG. 4A depicts a schematic representation of a process to predict the crop yield of a field. In step 402, images of one or more fields are gathered over time by the information gathering unit 110. In one embodiment, the images are gathered from low flying aircraft over one or more growing seasons. In step 404, the information gathering unit 110 receives information from farm equipment operating on each field. The equipment information may include the geographic location of the equipment over time, the equipment velocity at a given time, and a vector map of the equipment as it moves through the field which is used to determine seed density at any position in the field. In step 406, the information analysis unit 112 gathers agronomic rules to be applied to each of the tiles. In one embodiment, the agronomic rules are rules gathered from professional agronomists relating the crop type and field type similar to the crop type and field type in the images. In step 408, each field image is separated into a plurality of equal sized tile. In one embodiment, the tiles are 512×512 pixels by the pixel analysis unit 114. Each tile is downsized using cubic resampling to produce images having 20 cm/pixel resolution. The tiles are split into groups for training, validation and testing. Tiles containing less ten percent of data are discarded.

In step 410, the agronomic rules are applied to each tile. The normalized vegetation index (NDVI) and green normalized vegetation index (GDVI) are determined across each tile by the pixel analysis unit 114. Each tile is then analyzed by the pixel analysis unit 114 by applying erosion, blurring, threshold and connected components to identify anomalous regions in each tile. Each field is then represented as an s=4 non-mutually exclusive binary mask F corresponding to agronomic rules previously gathered as high stress, low biomass, low vigor and low growth associated with the field. Each image of the field is evaluated to create a feature map defined by the following equation:

$${F}^{s} = {\sum }_{t = 1}^{p} {F}_{t}^{s}$$

Where F^{s} is the number of times in the first p aircraft flights in which the sth feature is present. For each tile, the features are calculated based on the mean, standard deviation, mean absolute deviation, standard deviation and 5^{th}, 25^{th}, 50^{th}, 75^{th}, 95^{th} percentiles of common agronomic indices such as NDVI, NDWI, SAVI, EVI and GRNDV. In one embodiment, the mean, standard deviation and skew of the red, green, blue and NIR histograms are calculated for each tile by the pixel analysis unit 114. In another embodiment, the mean, standard deviation and skew are calculate for the seeding rate distribution for each tile using the equipment information. In step 412, total yield of each tile is determined for each tile using the previously determined features of each tile. The information analysis unit determines the mean squared error between the actual and predicted yield using the following formula:

$${MSE}_{tile} = {\sum }_{i , j} {Y}_{ij} ∘ {M}_{i , j} - {\hat{Y}}_{total}$$

Where Mij is the mask corresponding to the same area whose elements are 1 if the area is managed and 0 otherwise and Ytotal is the single value yield calculated by the model.

FIG. 4B depicts a schematic representation of a process to estimate crop yield of a field. In step 420, images of one or more fields are gathered over time by the information gathering unit 110. In one embodiment, the images are gathered from low flying aircraft over one or more growing seasons. In step 422, the information gathering unit 110 receives information from farm equipment operating on each field. The equipment information may include the geographic location of the equipment over time, the equipment velocity at a given time, and a vector map of the equipment as it moves through the field which is used to determine seed density at any position in the field.

In step 424, the field application data is generated based on image data and equipment data without using any agronomic data. In step 426, the image is separated into tiles. In one embodiment, the tiles are each 512 by 512 pixels. In another embodiment, each tile is a 4 channel image having red, blue, green and NIR reflectance channels taken from a flight Ip. Each tile is scaled to bring the values of the pixels to the 0-2 range. In step 428, the pixels in each tile are analyzed by the pixel analysis unit 114 to determine a pixel level yield in each tile. For each image Xij a yield density of Yij in units/pixel is calculated. In step 430, the total yield is calculated by calculating the yield of each tile using the yield density. The total predicted yield is calculated using the following formula:

$$TotalPredictedYeild = {\sum }_{i , j} {\hat{Y}}_{ij} ∘ {M}_{ij}$$

Where Mij is the mask corresponding to the area whose elements are 1 if the area is managed and 0 if the area is not managed. Field level metrics are calculated by performing an aggregate over all tiles using the equation:

$${MSE}_{pixel} = {\sum }_{i , j} {‖ ( {Y}_{ij} - {\hat{Y}}_{ij} ) ∘ {M}_{ij} ‖}_{2}^{2}$$

Where the tile areas used are only managed portions of the tile area. In one embodiment, mean square error, mean absolute error and mean absolute precent error are calculated. In step 432, the average yield of the field is determined. The average field value is calculated using the following formula:

$$AverageFieldValue = \frac{\sum ( TileValue * TileArea )}{\sum ( TileArea )}$$

Where the tile area corresponds only to areas In the tiles which are planted. Mean square error, mean absolute error and mean absolute percent error are calculated using the totals.

FIG. 4C depicts a schematic representation of a process of determining crop yield using an encoder/decoder to determine filed crop yield with image data only. In step 440, image data is gathered from the information gathering unit 110. In step 442, the encoder/decoder analyzes the pixel density for each image. Using pixel density only, the encoder/decoder determines areas of the field producing more or less based on the level of stress displayed in each pixel value. The encoder/decoder analyzes the shades of each pixel to determine the stress level of all areas of the field ranging from no stress to high stress. The pixel by pixel analysis also identifies the yield density of each pixel to determine the total yield of the field in the image with very high accuracy using only image data. By identifying the stress levels of each area and the pixel and the yield density of each pixel, the encoder/decoder can accurately determine the predicted yield of each area of the field based on the image data only.

FIG. 5 depicts a schematic representation of a process of generating validation data for an image. In step 502, a tile is selected from an image of a field by the information gathering unit 110. In step 504, anomaly detection is performed on the tile by the information analysis unit 112. In one embodiment, the anomaly detection is performed based on NDVI of the image. In step 506, erosion and blurring are applied to the image to remove noise from the image by the pixel analysis unit 114. In one embodiment, erosion and blurring are performed on NDVI and GNDVI versions of the images. In step 508, each region in the tile is thresholded at three levels to create three severity levels by the pixel analysis unit 114. The severity levels along with the green and red differentials in each region are used to describe the tile. In step 510, each area in the image is classified based on the severity levels by the pixel analysis unit 114. In one embodiment, the areas are classified as high stress, low biomass, low vigor and low growth. In step 510, validation data is generated for each region in the image by the simulation unit 116. In one embodiment, the validation data is generated using Lasso, Random Forest and LightGBM algorithms using different security and classification levels in addition to raw RGBN data. In another embodiment, the longitude and latitude of each image region is included in the algorithm.

The validation data along with the training data can be used to improve the performance of the image analysis thereby improving the yield prediction for a field based on an image. As one having ordinary skill in the art would appreciate, using the processes described herein, the ability to accurately predict the yield from a farm field based on image analysis is greatly increased.

While various embodiments of the present invention have been described, it will be apparent to those of skill in the art that many more embodiments and implementations are possible that are within the scope of this invention. Accordingly, the present invention is not to be restricted except in light of the attached claims and their equivalents.

What is claimed:

1. A yield prediction system including:
an information gathering unit that retrieves a plurality of images of a field over a time period;
an information analysis unit that divides each image into a plurality of tiles;
a pixel analysis unit that gathers at least one agronomic rule to each tile; and
a simulation unit that determines the yield represented by each pixel in each image based on the agronomic rules and the analysis of each tile.

2. The yield prediction system of claim 1, wherein each tile is a four channel image having red, blue, green and NIR reflectance.

3. The yield prediction system of claim 1, wherein a mean square error, mean absolute error and mean absolute precent error are calculated for each tile.

4. The yield prediction system of claim 1, wherein only the areas of each tile that are managed are used in the analysis.

5. The yield prediction system of claim 1 wherein each tile is scaled to bring a value of a pixel in the tile to between 0-2.

6. The yield prediction system of claim 5, wherein an encoder/decoder analyzes the pixel density for each image.

7. The yield prediction system of claim 6, wherein the encoder/decoder analyzes shades of each pixel to determine a stress level of all areas of the field ranging from no stress to high stress.

8. The yield prediction system of claim 7, wherein erosion and blurring are applied to each tile to remove noise from the image by the pixel analysis unit.

9. The yield prediction system of claim 8 wherein using the stress levels of each area and the pixel and the yield density of each pixel, the encoder/decoder calculates the predicted yield of each area of the field based on the image data only.

10. The yield analysis unit of claim 9, wherein each area in the image is classified based on the severity levels.

11. A method of predicting a yield of a field including the steps of:
retrieving a plurality of images of a field over a time period via an information gathering unit;
dividing each image into a plurality of tiles via an information analysis unit;
gathering at least one agronomic rule to each tile via a pixel analysis unit; and
determining the yield represented by each pixel in each image based on the at least one agronomic rules and the analysis of each tile via a simulation unit.

12. The method of claim 11, wherein each tile is a four channel image having red, blue, green and NIR reflectance.

13. The method of claim 11, wherein a mean square error, mean absolute error and mean absolute precent error are calculated for each tile.

14. The method of claim 11, wherein only the areas of each tile that are managed are used in the analysis.

15. The method of claim 11, wherein each tile is scaled to bring a value of a pixel in the tile to between 0-2.

16. The method of claim 15, wherein an encoder/decoder analyzes the pixel density for each image.

17. The method of claim 16, wherein the encoder/decoder analyzes shades of each pixel to determine a stress level of all areas of the field ranging from no stress to high stress.

18. The method of claim 17, wherein erosion and blurring are applied to each tile to remove noise from the image by the pixel analysis unit.

19. The method of claim 18 wherein using the stress levels of each area and the pixel and the yield density of each pixel, the encoder/decoder calculates the predicted yield of each area of the field based on the image data only.

20. The method of claim 19, wherein each area in the image is classified based on the severity levels.
